(19) United States
(12) Patent Application Publication
(10) Pub. No.: US 2005/0137926 A1
(43) Pub. Date: Jun. 23, 2005

(54) Method and apparatus for dynamic device allocation for managing escalation of on-demand business processes

(75) Inventors: Liang-Jie Zhang, Cortlandt Manor, NY (US); Hong Cai, Beijing (CN); Wei B.J. Lu, Beijing (CN); John Youssef Sayah, Washington, DC (US); Li Hua Tang, Beijing (CN); Qing Bo Wang, Beijing (CN); Ben Bo Yang, Beijing (CN)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 10/738,374

(22) Filed: Dec. 17, 2003

(51) Int. Cl. G06F 17/60

(52) U.S. Cl. 705/9

(57) ABSTRACT

Resource allocation techniques are provided for use in managing escalation of on-demand business processes. For example, in one aspect of the invention, a technique for managing escalation of a business process comprises the following steps/operations. A request is obtained from a business process, the business process having one or more tasks associated therewith. The one or more tasks are mapped to one or more roles. One or more available resources are allocated for the one or more roles. At least one communication session is launched such that data associated with the business process may be transferred to the one or more allocated resources.

### FIELD OF THE INVENTION

The present invention relates to business process management and related resource allocation techniques and, more particularly, to resource allocation techniques for use in managing escalation of on-demand business processes.

### BACKGROUND OF THE INVENTION

Nowadays, a business entity or enterprise is not standalone anymore. Thus, an enterprise does not need to produce everything it needs. As a result, an enterprise can outsource portions of its business to its business partners as part of an overall business process. One example of a business process is a collaborative design process wherein several distributed entities participate in the design of a product over an information network such as the Internet or World Wide Web. An example of a business process that is internal to a company is the process of approving a purchase order for a purchase of some item and/or service by a company.

Existing business process integration (BPI) technologies target major transactional aspects of business-to-business (B2B) integration where the business processes are automatically executed under the control of a business process (BP) manager without much human interaction. A business process manager is typically found in B2B middleware provided by a variety of software vendors such as, by way of example only, the WebSphere Business Integration Suite available from IBM Corporation (Armonk, N.Y.).

However, human factors play a critical role in business processes especially under the condition where exceptions arise in the process. An example of an exception may be a. situation where a quick decision must be made by a human decision maker in a certain time frame to get a problem solved. Typically, a prompt response is required when an exception occurs during the business process in order to keep the process going. When an exception takes place, human-intervention may be required to manage the process.

In businesses with a typical multi-organization structure with an elaborate decision and management hierarchy, identifying and tracking the required decision makers is considered an escalation process. In an escalation, the responsible party or parties for deciding and re-directing a business activity are located and their intervention is solicited. An added complication to the process arises during the interaction between several companies that could be spread across the globe. In this situation, multiple parties may be interacting and the ability to direct the request for a response and locate the responsible party or combinations of parties becomes more involved.

An existing way to solve the problem is to apply a so-called “direct” approach. In the direct approach, a resource (e.g., a computing device) may be directly connected to the business process software and perform direct computations and accept direct input in an attempt to address a process exception. However, if there are any changes in the task being performed, the role filled by the resource, or the resource itself, then a failure may occur. The approach would not be practical in the aforementioned multi-company situation.

In an attempt to address this problem, it has been proposed to introduce a communications service into the business process to facilitate exception handling. However, there is currently no common framework for use in integrating people into the communications service of a business process. Most existing solutions utilize proprietary communications methods. For example, the existing BP manager uses a proprietary format for requests issued to computing devices of people involved in the particular problem. A response returned from the computing device also uses proprietary format.

In addition, the communication procedure is usually hard coded in the BP manager. Since people may use various kinds of communication devices simultaneously, and the BP manager is required to handle various kinds of devices as well as their relationships, this adds great burden to the BP manager. Also, it is difficult to extend the BP manager to support new devices in real-time. Another deficiency of existing business process technologies is that the request issued by the BP manager is commonly communication-centric instead of business process task-centric. Moreover, control of process flow execution is done manually and in an ad hoc style.

It would therefore be highly advantageous to provide techniques for adaptively introducing human decision making into the execution of a business process for general process management and related exception handling. It would also be highly advantageous to provide techniques for dynamically allocating devices for getting decisions from people as well as returning results from people to the business process and restoring the interrupted operation of the business process. It would also be highly advantageous to provide techniques for assisting in a new, extended business collaboration between companies utilizing outsourcing to provide services and products.

### SUMMARY OF THE INVENTION

The present invention provides resource allocation techniques for use in managing escalation of on-demand business processes.

In a first aspect of the invention, a technique for managing escalation of a business process comprises the following steps/operations. A request is obtained from a business process, the business process having one or more tasks associated therewith. The one or more tasks are mapped to one or more roles. One or more available resources are allocated for the one or more roles. At least one communication session is launched such that data associated with the business process may be transferred to the one or more allocated resources.

The technique may further comprise decomposing the one or more tasks associated with the business process into one or more subtasks. The mapping step/operation may further comprise mapping the one or more subtasks to one or more roles. The technique may also further comprise the step/operation of adding annotation to the one or more tasks such that at least a portion of the annotation may be transferred to the one or more allocated resources. The technique may also further comprise the step/operation of obtaining one or more responses from the one or more resources.

Further, the technique may also comprise the step/operation of performing one or more actions. The action performing step/operation may further comprise one or more of: launching a new communication session based on at least a portion of the one or more responses from the one or more allocated resources or a task management policy; reallocating one or more new resources; aggregating the one or more responses from the one or more allocated resources; and providing a response to the business process.

Still further, one or more individuals may be associated with the one or more roles. The one or more resources may comprise one or more computing devices.

In a second aspect of the invention, a system for managing escalation of a business process comprises a business communication controller operative to: (i) obtain a request from a business process, the business process having one or more tasks associated therewith; (ii) map the one or more tasks to one or more roles; (iii) allocate one or more available resources for the one or more roles; and (iv) launch at least one communication session such that data associated with the business process may be transferred to the one or more allocated resources. The business communication controller may further comprise at least one of a task manager, a role manager, a business process task annotation broker and a business process adaptation device manager. The task manager may manage a life cycle of a task. A life cycle of a task may comprise at least one of an initialization stage, a proceeding stage and a post-processing stage.

In a third aspect of the invention, a method of providing a service, in accordance with a service provider, to manage escalation of a business process comprises the step of deploying a business communication controller operative to: (i) obtain a request from a business process, the business process having one or more tasks associated therewith; (ii) map the one or more tasks to one or more roles; (iii) allocate one or more available resources for the one or more roles; and (iv) launch at least one communication session such that data associated with the business process may be transferred to the one or more allocated resources.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a business communication controller according to an embodiment of the present invention;

FIG. 2 is a diagram illustrating a working process associated with a business communication controller according to an embodiment of the present invention;

FIG. 3 is a diagram illustrating an iteration and loop associated with execution of a communication session according to an embodiment of the present invention;

FIG. 4 is a diagram illustrating a business communication controller based on the Session Initiation Protocol (SIP) according to an embodiment of the present invention;

FIG. 5 is a diagram illustrating a process for handling a task according to an embodiment of the present invention; and

FIG. 6 is a diagram illustrating an illustrative hardware implementation of a computing system in accordance with which one or more components/methodologies of the present invention may be implemented according to an embodiment of the present invention.

### DETAILED DESCRIPTION OF PREFERRED EMBODIMENTS

The following description will illustrate the invention, from time to time, using exemplary business process applications (e.g., purchasing, design, etc.). It should be understood, however, that the invention is not limited to use with any particular application. Rather, the invention is more generally applicable to any application in which it is desirable to provide adaptive resource (e.g., device) allocation in a collaborative environment, e.g., B2B applications, etc.

In a business process, such as product design, there are several activities with a defined end-goal and generally associated with a time line. These activities or business tasks are usually interdependent and certain business tasks in any project cannot proceed until their dependencies on other tasks or other internal and external issues are resolved. The resolution of these issues is achieved by the individual whose roles are generally well-determined in terms of responsibilities of managing and executing business tasks.

In a business entity with a hierarchy and multiple organizations and divisions, lines of responsibilities and roles are defined generally inside organizations across division boundaries. Resolution of any business and execution issues of a business task may involve multiple groups and individuals requiring decision making by the responsible parties. This process may engage, and generally does, traversal of organization hierarchies in what we term as an escalation. A similar situation arises, although in a more complex fashion, as a business task or a function is carried out across multiple companies. Generally communications are required between interacting entities and individuals during the execution of a business task and the method of communications varies depending on the execution environment. It ranges from telephone calls, to mail notification (generated by humans or machines) to other forms of known communications.

With the advent of pervasive communication devices such as cellular phones, personal digital assistants and with cross-company and occasionally cross-country work, it is becoming customary to think of communication devices as an integral part during the execution of a business process activity. This applies to both a normal process and an exception handling or an escalation management situation. The execution of a business task usually involves a large number of process activities and business communication activities, these will be referred to henceforth as tasks.

The present invention provides an integrated mechanism for introducing human intervention for managing escalation of an on-demand business process by performing one or more of task decomposition, assignment, communication session launching, result annotation, iteration process and result aggregation, and annotation, to help return the human-interrupted business process back to normal automated model control.

Furthermore, the present invention introduces a component referred to as a business communication controller (BCC) into business processes. The BCC provides a uniform framework for integrating people into business processes for effective execution, as well as for preserving and resuming business process execution flow. The BCC may serve as an assistant to the BP manager. As mentioned above, a BP manager may be found in B2B middleware provided by a variety of software vendors such as, by way of example only, the WebSphere Business Integration Suite available from IBM Corporation (Armonk, N.Y.).

In accordance with a BCC of the invention, resources can be allocated so as to quickly respond to the dynamic environment of a business process, inside or across enterprises. A BCC may accept a well formatted request from a business process, provide communications service to connect the roles involved in the business process, and eventually get and return results to the business process. Further, techniques for getting people together and communicating using various devices, and recovering from failures that may occur during communications, may be transparently performed in accordance with a BCC of the invention.

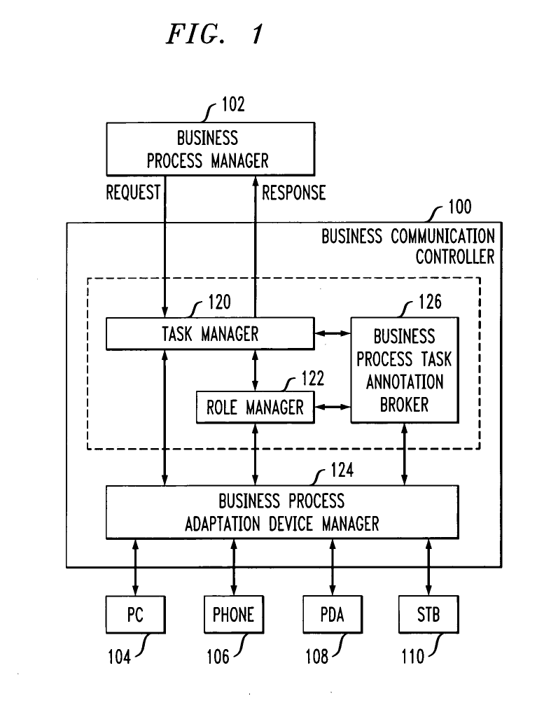

Referring initially to FIG. 1, a diagram illustrates a business communication controller according to an embodiment of the present invention. BCC 100 acts as a bridge between BP manager 102 and pervasive devices used by people involved in the business, e.g., personal computer (PC) 104, phone 106, personal digital assistant (PDA) 108, set top box (STB) 110. BCC 110 interfaces with BP manager 102 via a well-defined request/response format.

As shown, BCC 100 comprises task manager 120, role manager 122, business process adaptation device manager 124 and business process task annotation broker 126. These main components of BCC 100 will now be described in detail below.

Task Manager (TM) 120

Task manager 120 receives the task requests submitted by BP manager 102. The task requests are decomposed into sub-tasks, then the sub-tasks are interpreted as communication sessions among participants. The term “task” corresponds to the life cycle of submitting a request to the system, getting necessary annotation data from the system, and then returning to the business process manager 102. Task manager 120 accepts a request in a message in a predefined format from the business process manager. The message may contain information like taskID (task identifier), roles involved in the task, interaction mode between the roles. The message may be expressed in an existing taskID which marks an update of a previous request. Task manager 120 then invokes role manager 122 to execute logic required by each role involved in the business process. Since a task may be decomposed, the final annotation of a task may be the result of aggregation.

Exception/escalation policies are defined for task decomposition. Annotation broker 126 annotates the policy for task decomposition, sub-task assignment, and performs the data translation for bridging the business process and human-centric communications.

Task manager 120 is also in charge of the life cycle management of a task which contains:

(1) Init stage: This stage initiates the task by playing some early media (e.g., announcement to the roles) and creates sessions.

(2) Proceeding stage: This stage changes the session parameter, records the details of the session, and invokes consultation services if necessary.

(3) Post-processing stage: This stage generates results from the process.

In addition to the life cycle management of the tasks, task manager 120 may also support, but is not limited to, the following functions:

(1) Sub-task and priority: The messages received by task manager 120 from business process task annotation broker 126 may contain sub-taskID and priority parameters, in addition to basic parameters. It is the task manager's responsibility to schedule the tasks according to the taskID/sub-taskID. Tasks with higher priority should be executed before tasks with normal priority or tasks with low priority

(2) Continue task or change task parameter (resubmit): Resubmission of a task is allowed by the system. However, the taskID or sub-taskID of the resubmitted request should be the same as the corresponding previous taskID or sub-taskID. After task manager 120 receives a resubmission, the pending (sub-) task should be canceled or changed according to predefined policies.

(3) Consultation service during a task runtime: Consultation services include communication services or data services (e.g., Web Services) needed before the task can go to the next step. Retrieving information from a stock Web Service during the execution is such an example. In that case, a Simple Object Access Protocol (SOAP) interface may be used.

Role Manager (RM) 122

Role manager 122 manages the assignment and task directing between role and responsibility. The term “role” refers to a logical entity with specific responsibilities. A role may be dynamically binding to one or more people. For example, “Procurement Manager” is a role, it has the right to approve the procurement requests. If the current procurement manager is Bob and he has a backup Alice, then the role “Procurement Manager” may be binding to both Bob and Alice. Role manager 122 is the component that actually allocates communication channels to the people (roles) involved in a specific task. It accepts parameters from task manager 120 and invokes device manager 124 to start the communications. Role manager 122 provides, as a main function, a Lightweight Directory Access Protocol LDAP (such as IBM Corporation's bluepage) type of directory service.

Business Process Adaptation Device Manager (DM) 124

Device manager 124 manages the relationship between people and the communication devices they use. One person may use multiple devices simultaneously. Device manager 124 may support various kinds of devices, such as PC 104, phone 106, PDA 108, STB 110, among many others. Device manager 124 is the component that actually establishes/changes sessions between the devices (signaling) and manages media transferred between the devices. Depending on device capability, the annotation broker 126 may (through device manager 124) collect semantic information from the devices during or after the sessions. The semantic information may be analyzed and processed to collect annotations.

Annotations are mechanisms to describe task specific information and could be generated at any of the components of BCC 100. In the case of the operation of device manager 124, information and session data may be parsed and some of the information may be repackaged as useful annotation for the rest of the BCC 100 components. For example, if the available device of the procurement manager can accept interactive multimedia messages, then semantic information (such as amount of parts to be ordered) can be collected from the message as part of the annotation data.

Further functions of device manager 124 include device selection and exception handling (e.g., reconnection/switching/roaming).

Business Process Task Annotation Broker (AB) 126

Annotation broker 126 is responsible for getting results from the communication sessions and returning the results to BP manager 102 (via task manager 120, although results could be sent by annotation broker 126 directly to BP manager 102). Different devices may generate annotation data at any time for any task and for any role. A main role of annotation broker 126 is to aggregate the information from different sources such as dual tone multi-frequency (DTMF) input, voice recognition results, browser input, etc.

It is to be appreciated that the above-mentioned annotation data could be any XML (Extensible Markup Language) based representation or other formats. While the invention is not limited to any particular annotation data format, in one embodiment, the annotation data may be in the form disclosed in the U.S. patent application identified by Ser. No. 10/665,699, filed on Sep. 19, 2003, and entitled “Methods and Apparatus for Information Hyperchain Management for On-Demand Business Collaboration,” the disclosure of which is incorporated by reference herein.

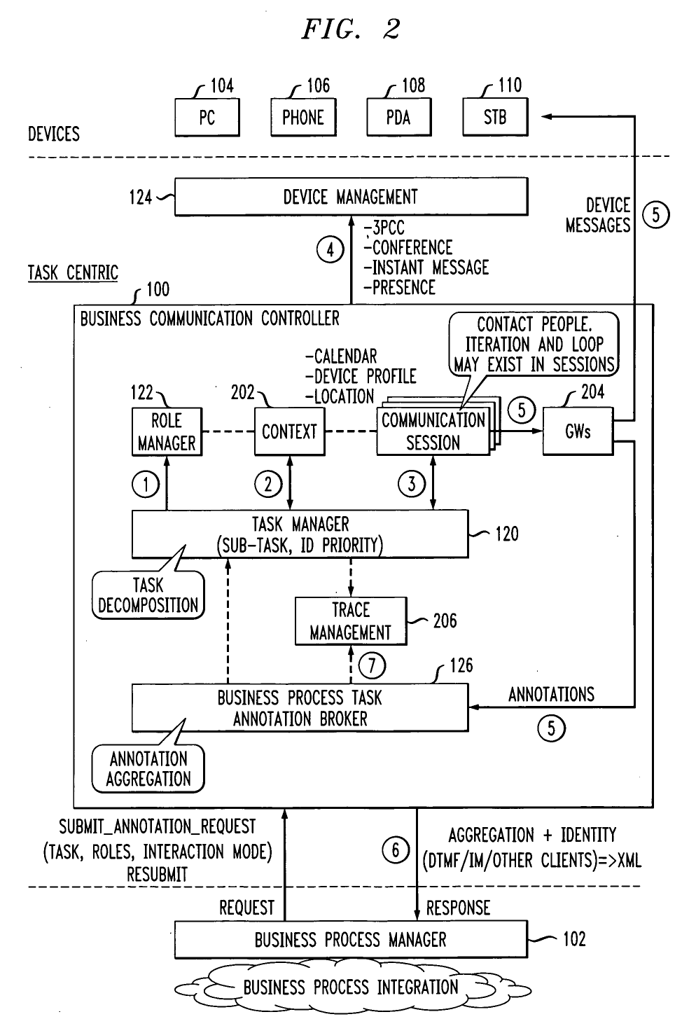

Referring now to FIG. 2, a diagram illustrates a working process associated with a business communication controller according to an embodiment of the present invention. More particularly, FIG. 2 depicts in more detail how BCC 100 works, given the above-described components as well as others shown in FIG. 2. Note that while device management block 124 is shown external to BCC 100 in FIG. 2 for the sake of illustrative clarity, it is preferably part of BCC 100. Nonetheless, such a functional block may be external to BCC 100.

The overall execution of the system during runtime is described as follows (it is to be understood that numbers 1 through 6 referenced below correspond to the circled numbers shown in FIG. 2):

(1) Decompose the task represented by the received request into sub-tasks assigned to specific roles.

(2) Determine the device used by the role from context information.

(3) Establish communication channels.

(4) Communication between the devices.

(5) Collect annotation data from different devices.

(6) Return aggregated annotation.

To facilitate the execution of the task, BCC 100 may further include the following auxiliary components:

Context Server 202

After RM (Role Management) 122 decides which role to communicate with, RM invokes context server 202 to get necessary context information for that person. Typical context information includes calendar/location/ON/OFF state of the person's mobile phone or of his/her Lotus Sametime client. Then, depending on the current context states of a person, “Communication Sessions” described below will be invoked which actually open the connection to the device.

Gateways 204

Different devices may be hosted on different networks, e.g., a handset on a Global System for Mobile (GSM) communications network, iPAQ (from Hewlett Packard) on a wireless local area network (LAN), XP messenger (from Microsoft Corporation) on Internet Protocol (IP) network, or even a Session Initiation Protocol (SIP) phone (hardware) connected to enterprise IP network, etc. A gateway is needed between the device's hosting network and IP network so that annotation data may be collected

Identity and Trace Management 206

The process executed by the system is part of a business process and may usually be considered critical. The security issue may be solved by including a “trace management” component in BCC 100. Whenever a new task is created, trace management module 206 allocates a new thread to monitor the whole process to make sure the connection is correct and secure and the information collected is really from the people using their own devices.

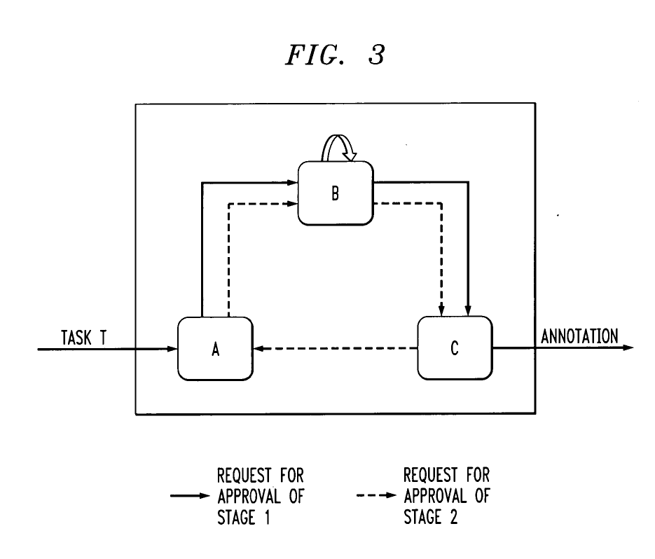

The (sub-) tasks will eventually be accomplished by communication sessions. The execution of a communication session may be iterative. In addition, a loop may occur in the execution of a communication session that belongs to the same task, as long as the communication context changes between the two subsequent execution times of a communication session so that deadlock will not occur. FIG. 3 is an example of the iteration and loop features in the execution of communication sessions.

Referring now to FIG. 3, a diagram illustrates an iteration and loop associated with execution of a communication session according to an embodiment of the present invention. In FIG. 3, task T is to get the approval from 3 people (A, B and C) on a two stage order. A stage is approved if two of the three people approve the stage. Only after stage one is approved can stage two be approved. B has a backup, so if B is not available, his backup could be contacted for approval.

To manage the communication sessions, a signaling protocol which is flexible enough to reach various kinds of devices in different kinds of networks plays a key role. In one illustrative embodiment, the Session Initiation Protocol (SIP) may be used as a signaling protocol. SIP is an Internet Engineering Task Force (IETF) protocol that is used to control multimedia sessions. SIP is also the de facto standard for real-time communication in the Internet. In addition, SIP is adopted by the 3rd Generation Partnership Project (3GPP) as the core signaling protocol for the 3G network. There are also standards to facilitate the inter-working between IP network and public switched telephone network (PSTN).

Thus, while other protocols may be employed, SIP is a preferred protocol to control the communication sessions in the business communication controller. SIP allows contacting multiple devices at the same time, and it may serve as the controller to set up communication channels like 3PCC (third party call control, which is a server-initiated call for peers participating in the call), conference (both inbound and outbound server are allowed), Instant Message (send Instant Messages from the server to the person) and presence (retrieve/notify presence information of a person).

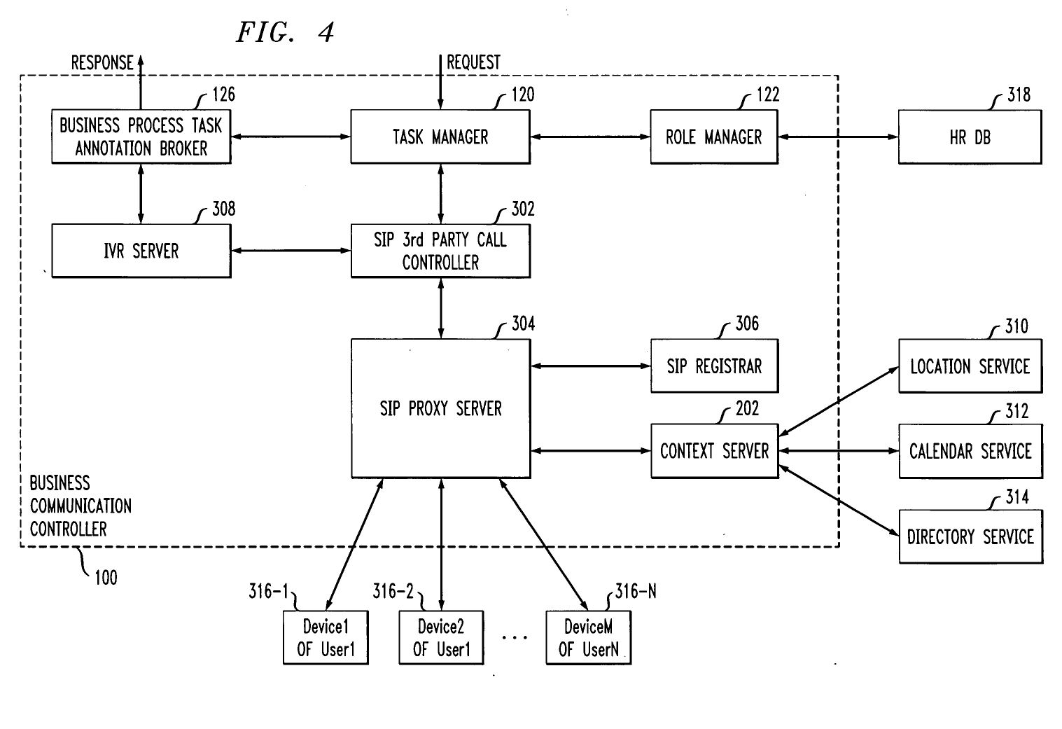

Referring now to FIG. 4, a diagram illustrates a BCC based on SIP according to an embodiment of the present invention. As shown, BCC 100 is depicted with the following components: task manager 120, role manager 122, annotation broker 126, context server 202, SIP 3rd party call controller 302, SIP proxy server 304, SIP registrar 306, interactive voice response (IVR) server 308. As further shown, BCC 100 interacts with location service 310, calendar service 312, directory service 314, device 316-A (e.g., office phone of Alice), device 316-B (personal computer of Bob), and human resources database 318.

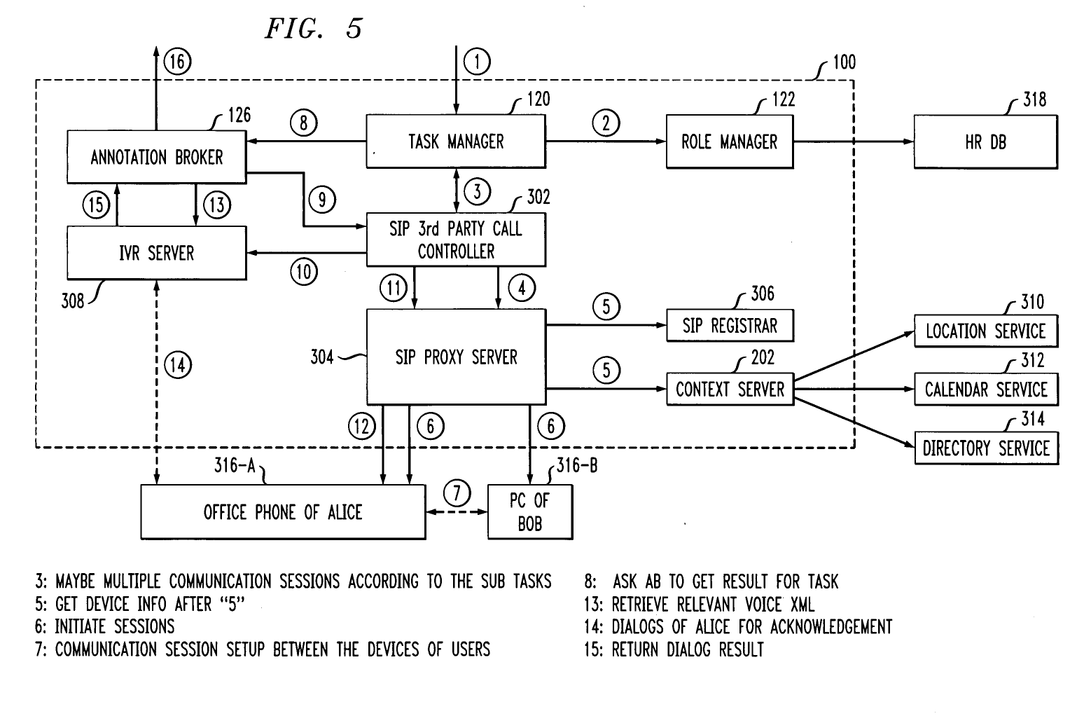

To better explain how the SIP implementation works, we present a working process for a sample task, i.e., a purchase order processing that requires a procurement manager and chief financial officer (CFO) to discuss and approve the purchase order. FIG. 5 is a diagram illustrating a process for handling such a sample task according to an embodiment of the present invention.

The overall execution of the purchase order process is described as follows (it is to be understood that numbers 1 through 16 referenced below correspond to the circled numbers shown in FIG. 5): The example purchase order process consists of the following steps:

(1) Task manager 120 receives request from BP manager 102.

(2) Task manager 120 queries role manager 122 for corresponding people (e.g., Procurement Manager is Alice, and CFO is Bob). Role manager 122 then queries HR DB 318 for the person who is binded to the role for the time being.

(3) Task manager 120 decomposes the task into communication procedures, and asks SIP 3rd party call controller 302 to execute each communication procedure.

(4) SIP 3rd party call controller 302 sends invitation to SIP proxy server 304.

(5) SIP proxy server 304 locates proper communication device (phone in the meeting room, soft phone client, Lotus Sametime client, etc.) by querying SIP registrar 306 (which stores the user profiles such as contact device addresses uploaded by user) and context server 202. The context information is consolidated from multiple sources, e.g., location service 310, calendar service 312 and directory service 314.

(6) SIP proxy server 302 sends invitation to devices 316-A and 316-B (e.g., Office phone of Alice and soft phone on Bob's PC, respectively).

(7) The media channel (if any) is setup between the devices.

(8) When the communication procedure among the roles finishes, task manager 120 asks annotation broker 126 to get the results of the task.

(9) Annotation broker 126 asks SIP 3rd party call controller 302 to call in a selected role (e.g., the Procurement Manager-Alice) to IVR server 308.

(10) SIP 3rd party call controller sends invitation to IVR server 308.

(11) SIP 3rd party call controller sends invitation to SIP proxy server 304.

(12) SIP proxy server 304 locates a device suitable for IVR (phone) and sends the invitation to the phone of Alice.

(13) IVR server 308 gets VoiceXML which is generated for interaction with the selected role by annotation broker 126.

(14) IVR server 308 interacts with Alice to get the result of the task.

(15) IVR server 308 returns the result to annotation broker 126.

(16) Annotation broker 126 wraps the result into a response and returns it to BP manager 102.

During the process, role manager 122 may query a human resources database (HR DB 318) to verify individual roles. In the case where other individuals in the organization hierarchy are required during an escalation process, HR DB 318 would be queries for the answer. Note that HR DB 318 could store information relevant to individuals from multiple organizations and companies that are partnering on a business task. Moreover, during step (5) above a directory service 314, a calendar service 312, or a location service 310 may be queried to check individuals availability and/or locations of the execution of a task.

The requests and responses sent to and from BCC 100 may use a standard format such as XML. Below is an example of a document type definition (DTD) describing a format that may be used:

| <?xml encoding=“US-ASCII”?> | |
|---|---|
| <!ELEMENT SIP_Request (task,roles,interaction)> | |
| <!ATTLIST SIP_Request | |
| Priority | CDATA #REQUIRED |
| is-resubmit | (yes\|no) ‘no’ |
| time | CDATA #REQUIRED> |
| <!ELEMENT task (#PCDATA)> | |
| <!ELEMENT roles (role)+> | |
| <!ELEMENT role (#PCDATA)> | |
| <!ELEMENT interaction (#PCDATA)> | |
| <!ELEMENT SIP_Response (identity,type,result)> | |
| <!ATTLIST SIP_Response | |
| time | CDATA #REQUIRED> |

<!ELEMENT identity (#PCDATA)>
<!ELEMENT type (#PCDATA)>
<!ELEMENT result (#PCDATA)>

The request and response in the business process illustrated in FIG. 4 are as follows:

Request:
<SIPBPI_Request priority=“1” resubmit=“false” time=“200211282030”>

```
<!-- ===============================================
Describing the tasks to be executed
================================================ -->
<task>Procurement-Approvement-Conference</task>
<!-- ===============================================
Describing roles involved in the task
================================================ -->
<roles>
    <role>ProcurementManager</role>
    <role>CFO</role>
</roles>
<!-- ===============================================
Describing interaction mode used in the task
Such as need to setup a conference
Or peer to peer meeting
May define asynchronous or synchronous way
================================================ -->
<interaction>conference </interaction>
```

</SIPBPI_Request
Response:
<?xml version=“1.0” encoding=“UTF-8”?>
<!DOCTYPE sipbpi SYSTEM “sipbpi.dtd”>

<!-- ===============================================
Credential used to verify the validation of the
Returned result, need to be integrated into other
Security infrastructure like PKI
================================================ -->
<identity>iuhiwqr#@$#@$*#@&/Aasfj</identity>
<!-- ===============================================
Describing the typeused tocollect the result
Like DTMF, voice, data, etc.
================================================ -->
<type>DTMF</type>
<!-- ===============================================
Describing the result collected from devices
that different roles involved in the task used
================================================ -->
<result>all-agree</result>

</SIPBPI_Response

In this implementation, SIP may be used to locate a user among several possible devices and transfer an ongoing session to another device. The request/response between BP manager 102 and BCC 100 may use XML format. The user may be synchronously called in for response. Mobility and presence of devices may be detected. Other implementations may use alternative solutions, such as using other signaling protocols serving similar functions as SIP, using non XML format for the request/response, asynchronously waiting for response from the user after sending notification to a detected proper device, allowing the user actively provide a response such as accessing a correlated web page and executing simple approval actions.

It is to be appreciated that the invention may also be implemented as a method of providing a service, in accordance with a service provider, to manage escalation of a business process. Such methodology may include the step of deploying a business communication controller (e.g., as described herein) at least operative to: (i) obtain a request from a business process, the business process having one or more tasks associated therewith; (ii) map the one or more tasks to one or more roles; (iii) allocate one or more available resources for the one or more roles; and (iv) launch at least one communication session such that data associated with the business process may be transferred to the one or more allocated resources.

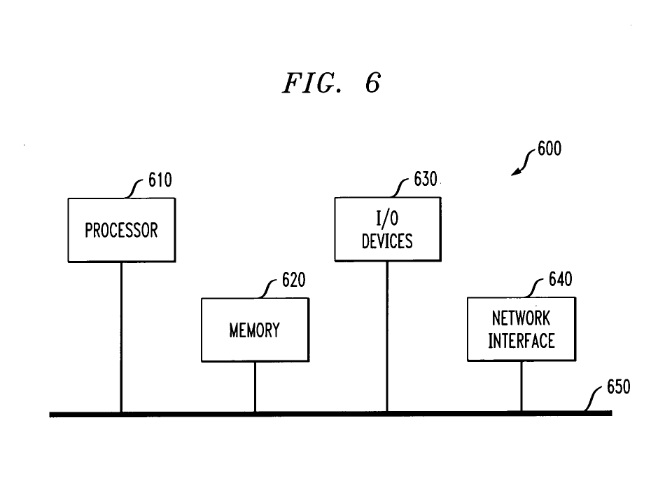

Referring finally to FIG. 6, a diagram illustrates an illustrative hardware implementation of a computing system in accordance with which one or more components/methodologies of the present invention (e.g., components/methodologies described in the context of FIGS. 1 through 5) may be implemented, according to an embodiment of the present invention. For instance, such a computing system in FIG. 6 may implement a business communication controller and its components in accordance with the invention. Also, the computing system in FIG. 6 may be used to implement other components discussed herein, e.g., devices, databases, services, etc.

It is to be understood that such individual components/methodologies may be implemented on one such computer system, or on more than one such computer system. In the case of an implementation in a distributed computing system, the individual computer systems and/or devices may be connected via a suitable network, e.g., the Internet or World Wide Web. However, the system may be realized via private or local networks. The invention is not limited to any particular network.

As shown, computer system 600 may be implemented in accordance with a processor 610, a memory 620, I/O devices 630, and a network interface 640, coupled via a computer bus 650 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., speaker, display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method of managing escalation of a business process, the method comprising the steps of:
obtaining a request from a business process, the business process having one or more tasks associated therewith;
mapping the one or more tasks to one or more roles;
allocating one or more available resources for the one or more roles; and
launching at least one communication session such that data associated with the business process may be transferred to the one or more allocated resources.

2. The method of claim 1, further comprising the step of decomposing the one or more tasks associated with the business process into one or more subtasks.

3. The method of claim 2, wherein the mapping step further comprises mapping the one or more subtasks to one or more roles.

4. The method of claim 1, further comprising the step of adding annotation to the one or more tasks such that at least a portion of the annotation may be transferred to the one or more allocated resources.

5. The method of claim 1, further comprising the step of obtaining one or more responses from the one or more resources.

6. The method of claim 1, further comprising the step of performing one or more actions.

7. The method of claim 6, wherein the action performing step further comprises launching a new communication session based on at least a portion of the one or more responses from the one or more allocated resources or a task management policy.

8. The method of claim 6, wherein the action performing step further comprises reallocating one or more new resources.

9. The method of claim 6, wherein the action performing step further comprises aggregating the one or more responses from the one or more allocated resources.

10. The method of claim 6, wherein the action performing step further comprises providing a response to the business process.

11. The method of claim 1, wherein one or more individuals are associated with the one or more roles.

12. The method of claim 1, wherein the one or more resources comprise one or more computing devices.

13. Apparatus for managing escalation of a business process, the apparatus comprising:
a memory; and
at least one processor coupled to the memory and operative to: (i) obtain a request from a business process, the business process having one or more tasks associated therewith; (ii) map the one or more tasks to one or more roles; (iii) allocate one or more available resources for the one or more roles; and (iv) launch at least one communication session such that data associated with the business process may be transferred to the one or more allocated resources.

14. An article of manufacture for managing escalation of a business process, comprising a machine readable medium containing one or more programs which when executed implement the steps of:
obtaining a request from a business process, the business process having one or more tasks associated therewith;
mapping the one or more tasks to one or more roles;
allocating one or more available resources for the one or more roles; and
launching at least one communication session such that data associated with the business process may be transferred to the one or more allocated resources.

15. A system for managing escalation of a business process, the system comprising:
a business communication controller operative to: (i) obtain a request from a business process, the business process having one or more tasks associated therewith; (ii) map the one or more tasks to one or more roles; (iii) allocate one or more available resources for the one or more roles; and (iv) launch at least one communication session such that data associated with the business process may be transferred to the one or more allocated resources.

16. The system of claim 15, wherein the business communication controller further comprises at least one of a task manager, a role manager, a business process task annotation broker and a business process adaptation device manager.

17. The system of claim 16, wherein the task manager manages a life cycle of a task.

18. The system of claim 17, wherein a life cycle of a task comprises at least one of an initialization stage, a proceeding stage and a post-processing stage.

19. A method of providing a service, in accordance with a service provider, to manage escalation of a business process, the method comprising the step of:
deploying a business communication controller operative to: (i) obtain a request from a business process, the business process having one or more tasks associated therewith; (ii) map the one or more tasks to one or more roles; (iii) allocate one or more available resources for the one or more roles; and (iv) launch at least one communication session such that data associated with the business process may be transferred to the one or more allocated resources.
